(19) United States
(12) Patent Application Publication
(10) Pub. No.: US 2026/0055336 A1
(43) Pub. Date: Feb. 26, 2026

(54) LIQUID LAUNDRY DETERGENT COMPOSITION

(71) Applicant: THE PROCTER & GAMBLE COMPANY, Cincinnati, OH (US)

(72) Inventors: Haiyan HUANG, Beijing (CN); Keyu GENG, Beijing (CN); Xialong ZUO, Beijing (CN); Kejing DU, Beijing (CN); Shingo ISHII, Singapore (SG); Michiko OHYA, Singapore (SG); Shuang GAO, Beijing (CN)

(21) Appl. No.: 19/303,609

(22) Filed: Aug. 19, 2025

(30) Foreign Application Priority Data
Aug. 20, 2024 (WO) PCT/CN2024/113337

(51) Int. Cl. C11D 1/14; C11D 3/00; C11D 3/20; C11D 3/37

(52) U.S. Cl. CPC C11D 1/14; C11D 3/0047; C11D 3/0084; C11D 3/2034; C11D 3/3723; C11D 2111/12

(57) ABSTRACT

The present invention relates to a cleaning composition, and particularly a liquid laundry detergent composition that is useful for treating fabrics with improved malodor control benefit.

### FIELD OF THE INVENTION

The present invention relates to a cleaning composition, and particularly a liquid laundry detergent composition that is useful for treating fabrics with improved malodor control benefit.

### BACKGROUND OF THE INVENTION

Laundry wash processes are designed to eliminate soils and stains from fabrics. Some soils and stains can generate malodors on fabrics. In some instances, these malodors can persist even after the laundry wash operation. Antioxidants have been used in detergent compositions to provide improved malodor control and reduction benefit.

On the other hand, typical consumer detergent compositions may have pH values ranging from 7 to as high as 11. However, low pH detergent compositions, e.g., compositions having a pH ranging from about 2 to about 6, can provide a variety of benefits. Low pH compositions may help reduce malodor on fabrics as well. Additionally, low pH compositions may aid in the release of calcium soaps that tend to capture soils on fabrics, improve performance on pH-sensitive stains, and even provide benefits on fabric feel.

However, the inventors noticed that these two technologies may not be compatible because low pH may cause reduced deposition of such antioxidants which then compromise the effect of the antioxidants in malodor control.

Therefore, there remains an ongoing need for a low pH liquid cleaning composition that is compatible with antioxidants.

### SUMMARY OF THE INVENTION

It is a surprising discovery of the present invention that when the liquid laundry detergent compositions employ a hindered phenol antioxidant in combination with a specific surfactant system, i.e., a relatively high level of a C₆-C₂₀ linear alkylbenzene sulfonate (LAS), the low pH environment can be compatible with the hindered phenol antioxidant.

In one aspect, the present invention relates to a liquid laundry detergent composition comprising:
a) from 0.001 wt % to 5 wt % of a hindered phenol antioxidant,
b) from 5 wt % to 60 wt % of a C₆-C₂₀ linear alkylbenzene sulfonate (LAS),
c) from 0.1 wt % to 30 wt % of an additional surfactant, and
d) from 4.5% to 40% by weight of the composition of an organic acid,
wherein the composition has a neat pH of from 1.5 to 5.0.

In some embodiments, the LAS is the main surfactant in the detergent composition, preferably wherein the LAS is the majority surfactant in the detergent composition.

In some embodiments, the hindered phenol antioxidant comprises at least one phenolic —OH group having: (a) at least one C₃-C₂₂ branched alkyl at a position ortho to said at least one phenolic —OH group; or (b) substitutes at each position ortho to said at least one phenolic —OH group, wherein said substitutes are independently selected from the group consisting of hydroxy, C₁-C₆ alkoxy, C₁-C₂₂ linear alkyl, and combinations thereof; wherein the hindered phenol antioxidant preferably comprises at least one phenolic —OH group having at least one C₃-C₆ branched alkyl at a position ortho to said at least one phenolic —OH group; wherein the hindered phenol antioxidant is more preferably an ester of 3,5-bis(1,1-dimethylethyl)-4-hydroxy-benzenepropanoic acid; and wherein said hindered phenol antioxidant is most preferably a C₁-C₂₂ linear alkyl ester of 3,5-bis(1,1-dimethylethyl)-4-hydroxy-benzenepropanoic acid.

In some embodiments, the additional surfactant is selected from the group consisting of alkyl alkoxylated alcohols, alkyl alkoxylated phenols, alkyl polysaccharides, polyhydroxy fatty acid amides, alkoxylated fatty acid esters, sucrose esters, sorbitan esters and alkoxylated derivatives of sorbitan esters, C₆-C₂₀ alkyl sulfates (AS), C₆-C₂₀ alkyl alkoxy sulfates (AAS), C₆-C₂₀ methyl ester sulfonates (MES), C₆-C₂₀ alkyl ether carboxylates (AEC), alpha olefin sulphonates (AOS), and any combinations thereof.

In some embodiments, the organic acid is selected from the group consisting of citric acid, lactic acid, tartaric acid, malic acid and any combinations thereof.

In some embodiments, said hindered phenol antioxidant is present in said liquid laundry detergent composition at an amount ranging from 0.005 wt % to 2 wt %, preferably from 0.01 wt % to 1 wt %, more preferably from 0.02 wt % to 0.5 wt %.

In some embodiments, the LAS is present in said liquid laundry detergent composition at an amount ranging from 6 wt % to 50 wt %, preferably from 7 wt % to 45 wt %, more preferably from 8 wt % to 40 wt %, for example 6 wt %, 7 wt %, 8 wt %, 9 wt %, 10 wt %, 12 wt %, 15 wt %, 17 wt %, 20 wt %, 25 wt %, 30 wt %, 35 wt %, 40 wt % or any ranges therebetween.

In some embodiments, the additional surfactant is present in said liquid laundry detergent composition at an amount ranging from 0.2 wt % to 30 wt %, preferably from 0.5 wt % to 25 wt %, more preferably from 1 wt % to 20 wt %, for example 1 wt %, 2 wt %, 3 wt %, 4 wt %, 5%, 10 wt %, 12 wt %, 15 wt %, 20 wt % or any ranges therebetween.

In some embodiments, the organic acid is present in said liquid laundry detergent composition at an amount ranging from 6 wt % to 30 wt % preferably from 7 wt % to 25 wt %, more preferably from 8 wt % to 20 wt %, for example 6 wt %, 7 wt %, 8 wt %, 9 wt %, 10 wt %, 12 wt %, 15 wt %, 17 wt %, 20 wt % or any ranges therebetween.

In some embodiments, the composition has a neat pH of from 1.6 to 4.5, preferably from 1.7 to 4.0, more preferably from 1.8 to 3.5, most preferably from 1.9 to 3.1, for example 1.6, 1.7, 1.8, 1.9, 2.0, 2.2, 2.5, 2.7, 3.0, 3.2, 3.5 or any ranges therebetween.

In some embodiments, the composition further comprises a polyalkylene imine polymer.

In some embodiments, the composition further comprises a treatment adjunct which is preferably selected from the group consisting of fatty acids and/or salts thereof, enzymes, encapsulated benefit agents, soil release polymers, hueing agents, builders, chelating agents, dye transfer inhibiting agents, dispersants, enzyme stabilizers, anti-oxidants, catalytic materials, bleaching agents, bleach catalysts, bleach activators, polymeric dispersing agents, soil removal/anti-redeposition agents, polymeric grease cleaning agents, amphiphilic copolymers, brighteners, suds suppressors, dyes, hueing agents, perfume, structure elasticizing agents, fabric softeners, carriers, fillers, hydrotropes, solvents, anti-microbial agents and/or preservatives, neutralizers and/or pH adjusting agents, processing aids, rheology modifiers and/or structurants, opacifiers, pearlescent agents, pigments, anti-corrosion and/or anti-tarnishing agents, and mixtures thereof.

In some preferred embodiments, the liquid laundry detergent composition further comprises one or more perfume raw materials selected from the group consisting of 1, 5-dimethyl-1-ethenylhex-4-enyl acetate, acetic acid 3-methyl-2-butenyl ester, 7-methyl-3-methylene-1,6-octadiene, acetic acid 3-methyl butyl ester, caprylic aldehyde, 2,2,6-trimethyl bicyclo(3.1.1) hept-2-ene, 3,7,7-trimethylbicyclo[4.1.0]hept-3-ene, hexyl ethanoate, 2,6-dimethyloct-7-en-2-ol, 1-(2,6,6-trimethyl-1-cyclohex-2-enyl) but-3-en-1-one, 2-methyl pentanoic acid ethyl ester, 1,8 9-para-menthadiene, 2,4-dimethyl-3-cyclohexene carboxaldehyde, 3,7-dimethyl-octan-3-ol, 2-(4-methyl-3-cyclohexen-1-yl)-2-propanyl acetate, 2,6,6-trimethyl bicyclo(3.1.1) hept-2-ene, 2-tert-butylcyclohexanol acetate, and any combinations thereof.

In some preferred embodiments, the liquid laundry detergent composition comprises:
from 0.02 wt % to 0.5 wt % of a hindered phenol antioxidant selected from the group consisting of C₁-C₂₂ linear alkyl esters of 3,5-bis(1,1-dimethylethyl)-4-hydroxy-benzenepropanoic acid and mixtures thereof;
from 8 wt % to 40 wt % of a C₁₀-C₂₀ linear alkyl benzene sulphonate (LAS);
from 2 wt % to 8 wt % of an additional surfactant selected from the group consisting of a C₁₀-C₂₀ linear or branched alkylethoxy sulfate (AES) having a weight average degree of ethoxylation ranging from 1 to 3, C₈-C₁₈ alkyl ethoxylated alcohols having a weight average degree of ethoxylation ranging from 7 to 10, a C₆-C₂₀ alkyl sulfates (AS), alpha olefin sulphonates (AOS), and any combinations thereof; and
from 8% to 20% by weight of the composition of a citric acid,
wherein the composition has a neat pH of from 2 to 3.

The present invention may also relate to the use of above-described liquid laundry detergent composition for removing malodor.

It is an advantage of the laundry detergent composition to deliver an improved malodor removal.

It is another advantage of the laundry detergent composition to deliver an improved flavor in headspace of the laundry detergent composition.

These and other features of the present invention will become apparent to one skilled in the art upon review of the following detailed description when taken in conjunction with the appended claims.

### DETAILED DESCRIPTION OF THE INVENTION

As used herein, the articles “a” and “an” when used in a claim, are understood to mean one or more of what is claimed or described.

As used herein, the terms “comprising,” “comprises,” “include”, “includes” and “including” are meant to be non-limiting.

As used herein, the term “substantially free of” or “substantially free from” means that the indicated material is present in an amount of no more than about 5 wt %, preferably no more than about 2%, and more preferably no more than about 1 wt %.

As used therein, the term “essentially free of” or “essentially free from” means that the indicated material is at the very minimal not deliberately added to the composition, or preferably not present at an analytically detectible level in such composition. It may include compositions in which the indicated material is present only as an impurity of one or more of the materials deliberately added to such compositions.

As used herein, the term “liquid” refers to a fluid having a liquid having a viscosity of from about 1 to about 2000 mPa*s at 25° C. and a shear rate of 20 sec-1. In some embodiments, the viscosity of the liquid may be in the range of from about 200 to about 1000 mPa*s at 25° C. at a shear rate of 20 sec-1. In some embodiments, the viscosity of the liquid may be in the range of from about 200 to about 500 mPa*s at 25° C. at a shear rate of 20 sec-1.

As used herein, the term “main surfactant” refers to a surfactant that is present in a composition at an amount that is greater than any other surfactant contained by such composition.

As used herein, the term “majority surfactant” refers to a surfactant that is present in a composition at an amount that is at least 50% by weight of the total surfactant content in such composition.

Unless otherwise specified, the term “molecular weight” as used herein refers to the weight average molecular weight (MWw) of the polymer chains in a polymer composition, which may be calculated using the equation:

$$MWw = ( \sum i Ni {Mi}^{2} ) / ( \sum i Ni Mi )$$

wherein Ni is the number of molecules having a molecular weight Mi.

Unless otherwise specified, the term “alkyl” as used herein means a hydrocarbyl moiety which can be linear or branched, substituted or unsubstituted.

As used herein, the term “hydrocarbyl” is defined herein as any organic unit or moiety which is comprised of carbon atoms and hydrogen atoms. Included with the definition of “hydrocarbyl” are the aromatic (aryl) and non-aromatic carbocyclic rings. Further included within the term hydrocarbyl are heterocycles. The term “heterocycle” includes both aromatic (heteroaryl) and non-aromatic heterocyclic rings.

All temperatures herein are in degrees Celsius (C) unless otherwise indicated. Unless otherwise specified, all measurements herein are conducted at 25° C. and under the atmospheric pressure. In all embodiments of the present invention, all percentages are by weight of the total composition, unless specifically stated otherwise. All ratios are weight ratios, unless specifically stated otherwise.

It is understood that the test methods that are disclosed in the Test Methods Section of the present application must be used to determine the respective values of the parameters of Applicants' inventions are described and claimed herein.

### Hindered Phenol Antioxidant

The liquid laundry detergent composition of the present invention contains at least one hindered phenol antioxidant, preferably in an amount sufficient to provide at least 25 ppb, more preferably at least 100 ppb, even more preferably at least 250 ppb, even more preferably at least 500 ppb, most preferably at least 1000 ppb, of an antioxidant concentration in the treatment liquor.

Without wishing to be bound by theory, it is believed that hindered phenol antioxidants may help to improve malodor control performance of the liquid laundry detergent compositions, particularly in combination with a surfactant system with a relatively high content of nonionic surfactants according to the present disclosure.

As used herein, the term “hindered phenol” is used to refer to a compound comprising a phenol group with substituent(s) at a position ortho to at least one phenolic —OH group. Preferably, the hindered phenol antioxidant used in the present invention comprises at least one phenolic —OH group having: (a) at least one C₃-C₂₂ branched alkyl at a position ortho to said at least one phenolic —OH group; or (b) substitutes at each position ortho to said at least one phenolic —OH group, wherein said substitutes are independently selected from the group consisting of hydroxy, C₁-C₆ alkoxy, C₁-C₂₂ linear alkyl, and combinations thereof.

Examples of such hindered phenol antioxidants may include, but are not limited to: 2,6-bis(1-methylpropyl)phenol; 2,6-bis(1,1-dimethylethyl)-4-methyl-phenol (also known as hydroxy butylated toluene or “BHT”); 2-(1,1-dimethylethyl)-1,4-benzenediol; 2,4-bis(1,1-dimethylethyl)-phenol; 2,6-bis(1,1-dimethylethyl)-phenol; 3,5-bis(1,1-dimethylethyl)-4-hydroxybenzene propanoic acid, methyl ester; 2-(1,1-dimethylethyl)-4-methylphenol; 2-(1,1-dimethylethyl)-4,6-dimethyl-phenol; 3,5-bis(1,1-dimethylethyl)-4-hydroxybenzenepropanoic acid, 1,1′-[2,2-bis[[3-[3,5-bis(1,1-dimethylethyl)-4-hydroxyphenyl]-1-oxopropoxy]methyl]-1,3-propanediyl]ester; 3,5-bis(1,1-dimethylethyl)-4-hydroxybenzenepropanoic acid, octadecyl ester; 2,2′-methylenebis[6-(1,1-dimethylethyl)-4-methylphenol; 2-(1,1-dimethylethyl)-phenol; 2,4,6-tris(1,1-dimethylethyl)-phenol; 4,4′-methylenebis[2,6-bis(1,1-dimethylethyl)-phenol; 4,4′,4″-[(2,4,6-trimethyl-1,3,5-benzenetriyl)tris(methylene)]tris[2,6-bis(1,1-dimethylethyl)-phenol]; N,N′-1,6-hexanediylbis[3,5-bis(1,1-dimethylethyl)-4-hydroxybenzenepropanamide; 3,5-bis(1,1-dimethylethyl)-4-hydroxy benzoic acid, hexadecyl ester; P-[[3,5-bis(1,1-dimethylethyl)-4-hydroxyphenyl]methylphosphonic acid, diethyl ester; 1,3,5-tris[[3,5-bis(1,1-dimethylethyl)-4-hydroxyphenyl]methyl]-1,3,5-Triazine-2,4,6 (1H,3H,5H)-trione; 3,5-bis(1,1-5 dimethylethyl)-4-hydroxybenzenepropanoic acid, 2-[3-[3,5-bis(1,1-dimethylethyl)-4-hydroxyphenyl]-1-oxopropyl]hydrazide; 3-(1,1-dimethyl ethyl)-4-hydroxy-5-methylbenzenepropanoic acid, 1,1′-[1,2-ethanediylbis(oxy-2,1-ethanediyl)]ester; 4-[(dimethylamino)methyl]-2,6-bis(1,1-dimethylethyl)phenol; 4-[[4,6-bis(octylthio)-1,3,5-triazin-2-yl]amino]-2,6-bis(1,1-dimethylethyl)phenol; 3,5-bis(1,1-dimethylethyl)-4-hydroxy benzene propanoic acid, 1,1′-(thiodi-2,1-ethanediyl)ester; 3,5-bis(1,1-dimethylethyl)-4-hydroxybenzoic acid, 2,4-bis(1,1-dimethylethyl)phenyl ester; 3,5-bis(1,1-dimethylethyl)-4-hydroxybenzenepropanoic acid, 1,1′-(1,6-hexanediyl)ester; 3-(1,1-dimethylethyl)-4-hydroxy-5-methylbenzenepropanoic acid, 1,1′-[2,4,8,10-tetraoxaspiro[5.5]undecane-3,9-diylbis(2,2-dimethyl-2,1-ethanediyl)]ester; 3-(1,1-dimethylethyl)-b-[3-(1,1-dimethylethyl)-4-hydroxy phenyl]-4-hydroxy-b-methylbenzenepropanoic acid, 1,1′-(1,2-ethanediyl)ester; 2-[[3,5-bis(1,1-dimethylethyl)-4-hydroxyphenyl]methyl]-2-butylpropanedioic acid, 1,3-bis(1,2,2,6,6-pentamethyl-4-piperidinyl)ester; 3,5-bis(1,1-dimethylethyl)-4-hydroxybenzenepropanoic acid, 1-[2-[3-[3,5-bis(1,1-dimethylethyl)-4-hydroxyphenyl]-1-oxopropoxy]ethyl]-2,2,6,6-tetramethyl-4-piperidinyl ester; 3,4-dihydro-2,5,7,8-tetramethyl-2-[(4R,8R)-4,8,12-trimethyltridecyl]-(2R)-2H-1-benzopyran-6-ol; 2,6-dimethylphenol; 2,3,5-trimethyl-1,4-benzenediol; 2,4,6-trimethylphenol; 2,3,6-trimethylphenol; 4,4′-(1-methylethylidene)-bis[2,6-dimethylphenol]; 1,3,5-tris[[4-(1,1-dimethylethyl)-3-hydroxy-2,6-dimethylphenyl]methyl]-1,3,5-triazine-2,4,6 (1H,3H,5H)-trione; 4,4′-methylenebis[2,6-dimethylphenol]; and mixtures thereof.

Additional antioxidants may be employed. Examples of suitable additional antioxidants for use include, but are not limited to, the group consisting of α-, β-, γ-, δ-tocopherol, ethoxyquin, 2,2,4-trimethyl-1,2-dihydroquinoline, 2,6-di-tert-butyl hydroquinone, tert-butyl hydroxyanisole, lignosulphonic acid and salts thereof, and mixtures thereof. It is noted that ethoxyquin (1,2-dihydro-6-ethoxy-2,2,4-trimethylquinoline) is marketed under the name Raluquin™ by the company Raschig™. Other types of antioxidants that may be used in the composition are 6-hydroxy-2,5,7,8-tetramethylchroman-2-carboxylic acid (Trolox™) and 1,2-benzisothiazoline-3-one (Proxel GXL™). Antioxidants such as tocopherol sorbate, butylated hydroxyl benzoic acids and their salts, gallic acid and its alkyl esters, uric acid and its salts, sorbic acid and its salts, and dihydroxyfumaric acid and its salts may also be useful. Other useful antioxidants may include tannins, such as tannins selected from the group consisting of gallotannins, ellagitannins, complex tannins, condensed tannins, and combinations thereof.

Preferably, the hindered phenol antioxidant comprises at least one phenolic —OH group having at least one C₃-C₆ branched alkyl at a position ortho to said at least one phenolic —OH group. For example, the hindered phenol antioxidant may be 2,6-bis(1,1-dimethylethyl)-4-methyl-phenol (BHT).

More preferably, the hindered phenol antioxidant is an ester of 3,5-bis(1,1-dimethylethyl)-4-hydroxy-benzenepropanoic acid, and most preferably a C₁-C₂₂ linear alkyl ester of 3,5-bis(1,1-dimethylethyl)-4-hydroxy-benzenepropanoic acid. Commercially available C₁-C₂₂ linear alkyl esters of 3,5-bis(1,1-dimethylethyl)-4-hydroxy-benzenepropanoic acid include RALOX® from Raschig USA (Texas, USA), which is a methyl ester of 3,5-bis(1,1-dimethylethyl)-4-hydroxy-benzenepropanoic acid, and TINOGARD® TS from BASF (Ludwigshafen, Germany), which is an octadecyl ester of 3,5-bis(1,1-dimethylethyl)-4-hydroxy-benzenepropanoic acid.

The above-described hindered phenol antioxidant may be present in the liquid laundry detergent composition of the present invention in an amount ranging from about 0.001 wt % to about 5 wt %, preferably from about 0.005 wt % to about 2 wt %, more preferably from about 0.01 wt % to about 1 wt %, most preferably from about 0.02 wt % to about 0.5 wt %.

In a particularly preferred embodiment, the liquid laundry detergent composition contains from about 0.02 wt % to about 0.5 wt % of a C₁-C₂₂ linear alkyl ester of 3,5-bis(1,1-dimethylethyl)-4-hydroxy-benzenepropanoic acid.

### Surfactant System

In addition to the hindered phenol antioxidants described hereinabove, the liquid laundry detergent composition of the present invention also includes a surfactant system comprising one or more surfactants selected from the group consisting of anionic surfactants, nonionic surfactants, zwitterionic surfactants, amphoteric surfactants, cationic surfactants, and combinations thereof. The total surfactant content of such liquid laundry detergent composition may range from about 10% to about 90%, preferably from about 10% to about 80%, more preferably from about 15% to about 60% by total weight of the composition.

Nonionic surfactants that can be included into the liquid laundry detergent composition of the present invention may be any conventional nonionic surfactants, including but not limited to: alkyl alkoxylated alcohols, alkyl alkoxylated phenols, alkyl polysaccharides, polyhydroxy fatty acid amides, and the like. Preferred nonionic surfactants are those of the formula R¹(OC₂H₄)ₙOH, wherein R¹ is a C₈-C₁₈ alkyl group or alkyl phenyl group, and n is from about 1 to about 80. Particularly preferred are C₈-C₁₈ alkyl ethoxylated alcohols having a weight average degree of ethoxylation from about 1 to about 20, preferably from about 5 to about 15, more preferably from about 7 to about 10, such as NEODOL® nonionic surfactants commercially available from Shell.

Other non-limiting examples of nonionic surfactants useful herein include: C₆-C₁₂ alkyl phenol alkoxylates where the alkoxylate units may be ethyleneoxy units, propyleneoxy units, or a mixture thereof; C₁₂-C₁₈ alcohol and C₆-C₁₂ alkyl phenol condensates with ethylene oxide/propylene oxide block polymers such as Pluronic® from BASF; C₁₄-C₂₂ mid-chain branched alcohols (BA); C₁₄-C₂₂ mid-chain branched alkyl alkoxylates, BAEₓ, wherein x is from 1 to 30; alkyl polysaccharides, specifically alkyl polyglycosides; Polyhydroxy fatty acid amides; and ether capped poly(oxyalkylated) alcohol surfactants. Suitable nonionic surfactants also include those sold under the tradename Lutensol® from BASF.

The nonionic surfactants can be provided in the liquid laundry detergent compositions of the present invention at levels ranging from about 0.5 wt % to about 60 wt %, preferably from about 0.8 wt % to about 50 wt %, more preferably from about 1 wt % to about 30 wt %, most preferably from about 2 wt % to about 20 wt %. In one particularly preferred embodiment, the liquid laundry detergent composition contains from about 2 wt % to about 10 wt % of a C₈-C₁₈ alkyl ethoxylated alcohol having a weight average degree of ethoxylation ranging from about 7 to about 10.

Anionic surfactants that are used in the liquid laundry detergent compositions of the present invention are preferably non-soap synthetic anionic surfactants, such as the water-soluble salts, preferably the alkali metal salts and/or ammonium salts, of organic sulphonic reaction products having in their molecular structure an alkyl group (included in the term “alkyl” is the alkyl portion of acyl groups) containing from about 10 to about 20 carbon atoms and a sulphonic/phosphonic acid or sulfuric/phosphoric acid ester group. Examples of suitable synthetic anionic surfactants include, but are not limited to: C₁₀-C₂₀ linear alkyl benzene sulphonates, C₁₀-C₂₀ linear or branched alkyl sulfates, C₁₀-C₂₀ linear or branched alkylethoxy sulfates having a weight average degree of ethoxylation ranging from 0.1 to 5.0, C₁₀-C₂₀ linear or branched alkyl ester sulfates, C₁₀-C₂₀ linear or branched alkyl sulphonates, C₁₀-C₂₀ linear or branched alkyl ester sulphonates, C₁₀-C₂₀ linear or branched alkyl phosphates, C₁₀-C₂₀ linear or branched alkyl phosphonates, C₁₀-C₂₀ linear or branched alkyl carboxylates, and combinations thereof (including their sodium, potassium, and/or ammonium salts).

Especially preferred for the practice of the present invention are anionic surfactants containing C₁₀-C₂₀ linear alkyl benzene sulphonates (LAS) and C₁₀-C₂₀ linear or branched alkylethoxy sulfates (AES) having a weight average degree of ethoxylation ranging from about 0.1 to about 5, preferably from about 0.5 to about 4, more preferably from about 1 to about 3. In a particularly preferred embodiment of the present invention, the liquid laundry detergent composition comprises both the LAS and AES.

The anionic surfactants can be provided in the liquid laundry detergent compositions of the present invention at levels ranging from about 1 wt % to about 45 wt %, more preferably from about 2 wt % to about 30 wt %, more preferably from about 3 wt % to about 25 wt %, and most preferably from about 5 wt % to about 20 wt %. In one particularly preferred embodiment, the liquid laundry detergent composition contains from about 5 wt % to about 20 wt % of LAS and AES, while the AES has a weight average degree of ethoxylation ranging from about 1 to about 3. The weight ratio between LAS and AES preferably ranges from 2:1 to 20:1, preferably from 2:1 to 10:1, more preferably from 2:1 to 8:1.

Other surfactants useful herein include amphoteric surfactants, zwitterionic surfactants and cationic surfactants. Such surfactants are well known for use in laundry detergents and are typically present at levels from about 0.1 wt %, 0.2 wt % or 0.5 wt % to about 5 wt %, 10 wt % or 20 wt %.

In a preferred but not necessary embodiment of the present invention, the liquid laundry detergent composition further contains from about 0.2 wt % to about 10 wt % of one or more amphoteric and/or zwitterionic surfactants.

Preferred amphoteric surfactants are selected from the group consisting of amine oxide surfactants, such as, for example, alkyl dimethyl amine oxide or alkyl amido propyl dimethyl amine oxide, more preferably alkyl dimethyl amine oxide and especially coco dimethyl amino oxide. Amine oxide may have a linear or mid-branched alkyl moiety. Typical linear amine oxides are characterized by a formula R₁—N(R₂)(R₃)—O, wherein R¹ is a C₈-18 alkyl, and wherein R² and R³ are independently selected from the group consisting of C₁-3 alkyls and C₁-3 hydroxyalkyls, such as methyl, ethyl, propyl, isopropyl, 2-hydroxethyl, 2-hydroxypropyl and 3-hydroxypropyl. As used herein “mid-branched” means that the amine oxide has one alkyl moiety having n1 carbon atoms with one alkyl branch on the alkyl moiety having n2 carbon atoms. The alkyl branch is located on the a carbon from the nitrogen on the alkyl moiety. This type of branching for the amine oxide is also known in the art as an internal amine oxide. The total sum of n1 and n2 is from about 10 to about 24 carbon atoms, preferably from about 12 to about 20, and more preferably from about 10 to about 16. The number of carbon atoms for the one alkyl moiety (n1) should be approximately the same number of carbon atoms as the one alkyl branch (n2) such that the one alkyl moiety and the one alkyl branch are symmetric. As used herein “symmetric” means that |n1−n2| is less than or equal to 5, preferably 4, most preferably from 0 to 4 carbon atoms in at least about 50 wt %, more preferably at least about 75 wt % to about 100 wt %, of the mid-branched amine oxides for use herein. Particularly preferred amphoteric surfactants are C₁₀-C₁₄ alkyl dimethyl amine oxides. Preferred zwitterionic surfactants are betaine surfactants, such as, for example, alkyl betaines, alkylamidobetaines, amidazoliniumbetaines, sulfobetaines (also referred to as sultaines) as well as phosphobetaines. A particularly preferred betaine is cocoamidopropylbetaine.

Water-soluble salts of the higher fatty acids, i.e., “soaps”, are also useful anionic surfactants in the liquid laundry detergent compositions of the present invention, although such soaps are not counted when calculating the NI-to-AI weight ratio in the present invention. Suitable soaps include alkali metal salts (such as the sodium, potassium, ammonium, and alkyl ammonium salts) of higher fatty acids containing from about 8 to about 24 carbon atoms, and preferably from about 12 to about 18 carbon atoms. Soaps can be made by direct saponification of fats and oils or by the neutralization of free fatty acids. Particularly useful are the sodium and potassium salts of the mixtures of fatty acids derived from coconut oil and tallow, i.e., sodium or potassium tallow and coconut soap. However, the liquid laundry detergent compositions of the present invention preferably contain soaps at a relatively low level, e.g., no more than about 6 wt %, more preferably not more than about 2 wt % or 1 wt %, and most preferably said liquid laundry detergent compositions are substantially or essentially free of soaps.

### Liquid Laundry Detergent Compositions

The liquid laundry detergent composition of the present invention is suitable for fabric cleaning application, including automatic machine washing or hand-washing of fabrics, or cleaning auxiliaries, such as for example, bleach, rinse aids, additives or pre-treat types.

The liquid laundry detergent composition can be a fully formulated laundry detergent product. Liquid compositions contained in encapsulated and/or unitized dose products are included, as are compositions which comprise two or more separate but jointly dispensable portions. Preferably, the liquid laundry detergent composition contains water as an aqueous carrier, and it can contain either water alone or mixtures of organic solvent(s) with water as carrier(s). Suitable organic solvents are linear or branched lower C₁-C₈ alcohols, diols, glycerols or glycols; lower amine solvents such as C₁-C₄ alkanolamines, and mixtures thereof. Exemplary organic solvents include 1,2-propanediol, ethanol, glycerol, monoethanolamine and triethanolamine. The carriers are typically present at levels in the range of from about 0.1% to about 98%, preferably from about 10% to about 95%, more preferably from about 25% to about 75% by total weight of the liquid laundry detergent composition. In some embodiments, water is from about 85 to about 100 wt % of the carrier. In other embodiments, water is absent and the composition is anhydrous. Highly preferred compositions afforded by the present invention are clear, isotropic liquids.

The liquid laundry detergent composition of the present invention has a viscosity from about 1 to about 2000 centipoise (1-2000 mPa·s), or from about 200 to about 800 centipoises (200-800 mPa·s). The viscosity can be determined using a Brookfield viscometer, No. 2 spindle, at 60 RPM/s, measured at 25° C.

In a laundry washing solution, the through-the-wash (TTW) pH during the wash sub-cycle may be preferably from 2.5 to 6.0, preferably from 3.0 to 5.0, more preferably from 3.2 to 4.0.

The composition may further an anti-microbial agent which is a hydroxyl diphenyl ether. Preferably, the anti-microbial agent may be selected from the group consisting of 4-4′-dichloro-2-hydroxy diphenyl ether, 2,4,4′-trichloro-2′-hydroxy diphenyl ether, and a combination thereof.

In addition to those ingredients described hereinabove, the balance of the liquid laundry detergent composition of the present invention typically contains from about 5 wt % to about 70 wt %, or about 10 wt % to about 60 wt % of adjunct ingredients. Suitable adjunct ingredients for laundry detergent products include: builders, chelating agents, dye transfer inhibiting agents, dispersants, rheology modifiers, enzymes, and enzyme stabilizers, catalytic materials, bleach activators, hydrogen peroxide, sources of hydrogen peroxide, preformed peracids, polymeric dispersing agents, clay soil removal/anti-redeposition agents, brighteners, suds suppressors, dyes, photobleaches, structure elasticizing agents, fabric softeners, carriers, hydrotropes, processing aids, solvents, hueing agents, anti-microbial agents, perfumes (including neat perfume oils and/or perfume microcapsules), and/or pigments. The precise nature of these adjunct ingredients and the levels thereof in the liquid laundry detergent composition will depend on factors like the specific type of the composition and the nature of the cleaning operation for which it is to be used. The liquid laundry detergent composition of the present invention may be formed by any suitable process. For example, it can be formed by mixing the above-mentioned ingredients simultaneously or sequentially. In a preferred embodiment, the hindered phenol antioxidant is added as a part of an emulsified pre-mixture that is formed by mixing the hindered phenol antioxidant with an emulsifier. Further, in order to stabilize the hindered phenol antioxidant and protect it against alkalinity during the manufacturing process, it is desirable to add a small amount of weak acid into the pre-mixture.

### Methods of Using the Liquid Laundry Detergent Composition

The present invention in one aspect is directed to a method of using the above-described liquid laundry detergent composition for treating fabrics, the method comprising the steps of: (i) providing a liquid laundry detergent composition as described above; (ii) forming a laundry liquor by diluting the liquid laundry detergent composition with water; (iii) washing fabric in the laundry liquor; and (iv) rinsing the fabric in water.

Machine laundry methods may comprise treating soiled fabrics with an aqueous wash solution in a top-loading or front-loading automatic or semi-automatic washing machine having dissolved or dispensed therein an effective amount of a liquid laundry cleaning composition in accord with the invention. An “effective amount” of the liquid laundry detergent composition means from about 10 g to about 300 g of product dissolved or dispersed in a wash solution of volume from about 5 L to about 65 L. The water temperatures may range from about 5° C. to about 100° C. The water to soiled fabric ratio may be from about 1:1 to about 30:1. The liquid laundry detergent compositions may be employed at concentrations of from about 200 ppm to about 15,000 ppm in solution. The detergent dosage levels may also vary depending not only on the type and severity of the soils and stains, but also on the wash water temperature, the volume of wash water, and the type of washing machine (e.g., top-loading, front-loading, vertical-axis Japanese-type automatic washing machine).

The liquid laundry detergent compositions herein may be used for laundering of fabrics at reduced wash temperatures. These methods of laundering fabric comprise the steps of delivering a liquid laundry detergent composition to water to form a wash liquor and adding a laundering fabric to said wash liquor, wherein the wash liquor has a temperature of from about 0° C. to about 20° C., or from about 0° C. to about 15° C., or from about 0° C. to about 9º° C. The fabric may be contacted to the water prior to, or after, or simultaneous with, contacting the liquid laundry detergent composition with water.

Hand washing/soak methods, and combined handwashing with semi-automatic washing machines, are also included.

### Test Methods

### Test 1: Fabric Deposition Test of Antioxidants

Antioxidants are extracted from treated fabrics by using the ultrasonication aided solvent extraction method described hereinafter. The resulting extract is then subjected to gradient reversed-phase high performance liquid chromatographic (HPLC) separation on a C₈ column and is quantified by tandem mass spectrometry (MS/MS) operating under multiple reaction monitoring (MRM) conditions at negative mode.

As a first step, about 0.8 grams of the treated fabrics is accurately weighed and then filled into a 50 mL PP centrifuge tube. The extraction protocol is run for about sixty (60) minutes using about 14 g methanol as the extraction solvent at 40° C. with aid of ultrasonication. The resulting extract is collected and centrifuged at 14000 rpm for 5 min. The supernatant is used as an injection sample for the subsequent LC-MS/MS analysis.

Next, about six (6) ul of the above-mentioned injection sample is injected and separated on a Waters ACQUITY UPLC C8 column with gradient from about 50% mobile phase A (0.1% formic water solution)/50% mobile phase B (0.1% formic acid in methanol) to 0% mobile phase A/100% mobile phase B in about five (5) minutes, and the final gradient is kept for another three (3) minutes. The antioxidant, for example Ralox®35, is detected at the negative MRM mode. The ion pair of m/z 291>73 is used as quantification transition, while m/z of 291>41 is used for identification.

Subsequently, standards in the range of 10 ng/ml to 1000 ng/ml are injected for creation of a calibration curve. Concentration of the antioxidant, for example Ralox®35, in the injection sample is determined by back-calculation using weighted (1/x) quadratic regression of the calibration curve.

### Test 2: Quantitative Test for Malodor Reduction

The following method is used to test the malodor reduction benefits of a composition. Fatty acids and malodor markers are added into 100 ml glass gar with Teflon-lined cap according to Table C and mixed well using a vortex.

TABLE C
Malodor marker composition

| | | % | Weight needed |
|---|---|---|---|
| Material | CAS # | Composition | (g) |
| Iso Valeric acid | 503-74-2 | 12.00 | 9.0 |
| Undecanal | 112-44-7 | 0.20 | 0.15 |
| Undecanoic | 112-37-8 | 62.80 | 47.1 |
| Acid | | | |
| Skatole | 83-34-1 | 1.00 | 0.75 |
| Decanoic Acid | 334-48-5 | 22.00 | 16.5 |
| Ethyl | 627-90-7 | 2.00 | 1.5 |
| undecanoate | | | |

Body Soil Malodor Composition is then prepared by adding the specified amount of each material according to Table D into a 200 mL glass jar with Teflon lined cap. Artificial body soil (ABS) is commercially available by Accurate Product Development; 2028 Bohlke Blvd, Fairfield, OH 45014.

TABLE D
Body soil malodor composition

| Material | Weight (g) |
|---|---|
| Malodor marker (from Table C) | 17.1 |
| Artificial Body Soil (ABS) | 15.8 |
| Di-propylene glycol monomethyl | 105 |
| ether (CAS: 34590-94-8) | |
| Squalene (CAS # 111-02-4) | 15.8 |

Next, sixteen (16) malodor test fabrics per wash load are prepared by applying 300 μl of Body soil malodor composition described in Table D to de-sized 2×5 inch white polycotton 50/50 (PCW50/50) swatches. About 51 grams of each liquid laundry detergent to be tested (see, e.g., Example 2, Table 3) is added to Japan National top loading automatic washing machine set to Normal cycle; 68° F. wash cycle followed by a 68° F. rinse cycle. Cincinnati, OH, USA soft water is mixed with hard water at known ratio to meet hardness target—This is done automatically by mixing station equipment installed on washing machines and coded algorithm. Malodor test fabrics are washed in 3 gpg wash water with 2.7 kg, 50×50 cm clean cotton and poly-cotton ballast then dried in a Maytag tumble drier set to low for 20 minutes. The dried fabrics are placed in a mylar bag and sealed for 24 hours.

Subsequently, the malodor reduction using ABS/Squalene malodor sensors are quantitatively determined by Gas Chromatography Mass Spectroscopy using an Agilent gas chromatograph 7890B equipped with a mass selective detector (5977B), a Chemstation quantitation package and a Gerstel multi-purpose sampler equipped with a solid phase micro-extraction (SPME) probe. Calibration standards of 6-Methyl-5-hepten-2-one (CAS 110-93-0), Trans-2-heptenal (18829-55-5) and 3-methyl-2-Butenal (107-86-8) are prepared by dissolving a known weight of these materials in light mineral oil (CAS 8020-83-5) (each material available from Sigma Aldrich). Fabrics are cut into uniform 2 inch by 2.5 inch pieces and placed in 10 mL headspace crimp vials. Vials are equilibrated greater than 12 hours before analysis. The following settings are used in the auto sampler: 80 C incubation temperature, 90 min incubation time, VT32-10 sample tray type, 22 mm vial penetration, 20 min extraction time, 54 mm injection penetration and 300 s desorption time. The following settings are used for the Front Split/Splitless inlet helium: split mode, 250 C temperature, 12 psi pressure, 79.5 mL/min total flow, 3 mL/min septum purge flow, 50:1 split ratio and 22.5 min GC run time. The follow settings are used in the oven: 40 C initial temperature, 12 C/min heating program, 250 C temperature and 5 min hold time. Based on the partition coefficients (K at 80 C) of each component, the total nMol/L liter of 6-Methyl-5-hepten-2-one (K=3353), Trans-2-heptenal (K=3434), and 3-methyl-2-Butenal (K=1119) are calculated.

The values of these three measurements (in nmoles/L) are added together to provide the Total ABS/Squalene Markers (nmoles/L) for a given test leg.

The % Malodor Reduction Oxidation Products is provided as a percentage comparing the reduction of the amount of selected malodor markers as provided by the test composition compared to the (nil-antioxidant) reference composition. The value is determined as follows:

$$\% Reduction Oxidation Products = ( Markersref - Markerstest ) \times 100 / Markersref$$

Values for Markersref and Markerstest are defined as follows:

$$Markersref = Total ABS / Squalene Markers ( nmoles / L ) of the fabrics washed with the formulation without antioxidant ( e . g . , the reference or control formulation )$$

$$Markerstest = Total ABS / Squalene Markers ( nmoles / L ) of the fabrics washed with the formulation with the tested antioxidant$$

As the measured oxidation products are typically considered malodorous, it is believed that the greater the % reduction of oxidation products provided by a composition, the less malodorous the treated fabrics are likely to be. Therefore, greater values of % Malodor Reduction Oxidation Products are typically preferred. The compositions and processes of the present disclosure may provide a % Malodor Reduction Oxidation Products value of at least about 10%, or at least about 20%, or at least about 30%, or at least about 40%, or at least about 50%, or at least about 60%, or at least about 70%, or at least about 80%.

Malodor reduction may also be reported as the difference between Markersref and Markerstest, thereby showing an absolute difference (e.g., Delta ABS/Squalene Oxidation).

### EXAMPLES

### Example 1: Deposition of Antioxidant in Low-pH Liquid Laundry Detergent Compositions Containing Different Levels of LAS

Four (4) sample liquid laundry detergent compositions were prepared containing the ingredients as shown in Table 1 below, in which Samples 1 to 3 comprise a surfactant system containing LAS as well as a relatively high level of citric acid (CA) resulting in low product pH (i.e. from around 2 to around 3), Sample 4 comprises a similar surfactant system with Sample 2 but low level of CA resulting in relatively high product pH (i.e., around 8.9).

TABLE 1

| | 1 | 2 | 3 | 4 |
|---|---|---|---|---|
| Ingredients (wt %) | (Low pH) | (Low pH) | (Low pH) | (High pH) |
| Citric acid | 10 | 10 | 10 | 0.6 |
| C₁₁₋₁₃LAS | 11.7 | 9.5 | 1.5 | 9.5 |
| C₁₂₋₁₄AE₃S | 6.0 | 1.35 | 1.35 | 1.35 |
| C₁₂₋₁₄EO₇ | — | 6.0 | 14 | 6.0 |
| NaCS | 3.0 | 1.5 | 3.0 | 1.5 |
| Antioxidant ^{a} | 0.075 | 0.075 | 0.075 | 0.075 |
| Polyethyleneimines ^{b} | 2.8 | 2.8 | 2.8 | 2.8 |
| Tinosan ®HP100 ^{c} | 0.03 | 0.03 | 0.03 | 0.03 |
| Water | Balance | Balance | Balance | Balance |
| Product pH | 2.50 | 2.46 | 2.70 | 8.9 |

^{a} Ralox ®35: Methyl ester of 3,5-bis(1,1-dimethylethyl)-4-hydroxy-benzenepropanoic acid.
^{b} Polyethyleneimines (PEI) polymer ethoxylated or ethoxylated and propoxylated, available from BASF
^{c} Tinosan ®HP100 is 4-4′-dichloro-2-hydroxy diphenyl ether, available from BASF

In order to determine the deposition of antioxidants after washing, fabric tracers were washed by using samples in Table 1 as shown below:

Washing test condition: 31.43 g/14 L (FL test condition), ˜16 gpg (BJ city water), washing water temperature is 28 C.

Tracers: CW98
1, Add city water
2, Add Samples in the washing machine
3, Put in fabric tracers (CW98), half SBL2004 sheet (commercialized artificial soil swatch in laundry industry including greasy oil, sebum, inorganic soils etc.) and balance to total 2.0 kg with clean fabrics (70% cotton, 30% polyester).
4, Start stirring for the main wash, main wash time is 17 minutes.
5, Remove the fabrics from the wash container and squeeze dry
6, Add city water, put in fabric tracers and start stirring (rinse)
7, The rinse time is 3 minutes.
8, Repeat steps 6 and 7 again.
9, Remove the fabrics from the rinse container and dry in natural air.
10, The washing cycle is repeated for 4 times in 4 different washing machines. Total 16 pieces tracers with 4 pieces internal replicates in each machine and each cycle.

Then, the deposition of the antioxidant on fabrics washed by using the above samples was determined in accordance with Test 1: Fabric Deposition Test of Antioxidants. The data reported is the average number based on 16 replicates.

Then, the deposition of the antioxidant on fabrics washed by using the above samples was determined in accordance with Test 1: Fabric Deposition Test of Antioxidants. The data reported is the average number based on 16 replicates.

TABLE 2

| | 1 | 2 | 3 | 4 |
|---|---|---|---|---|
| | (Low pH) | (Low pH) | (Low pH) | (High pH) |
| C₁₁₋₁₃LAS | 11.7 | 9.5 | 1.5 | 9.5 |
| Product pH | 2.50 | 2.46 | 2.70 | 8.9 |
| Antioxidant | 2.77 | 2.29 | 1.48 | 3.09 |
| Deposition (μg/g) | | | | |

As the data shown above, the low pH context may compromise the deposition of antioxidants (e.g., 2.29 μg/g for Sample 2 vs. 3.09 μg/g for Sample 4). Then, it is surprising and completely unexpected that the inventors discovered, in the context of low pH composition, the presence of a relatively high level of LAS can counteract the adverse effect of low pH environment for the deposition of the antioxidant. Specifically, the deposition of antioxidant is increasing along with the rising level of LAS in Samples 1 to 3. Accordingly, in the presence of a relatively high level of LAS, the low pH environment can be compatible with the hindered phenol antioxidant in liquid detergent compositions so as to deliver a benefit of malodor removal.

### Example 2: Deposition of Antioxidant in Low-pH Liquid Laundry Detergent Compositions Containing LAS Versus Other Anionic Surfactants

Four (4) sample liquid laundry detergent compositions were prepared containing the ingredients as shown in Table 3 below, in which Samples 5 to 8 comprise a surfactant system containing LAS or other anionic surfactants in the context of low product pH.

TABLE 3

| | 5 | 6 | 7 | 8 |
|---|---|---|---|---|
| Ingredients (wt %) | (Low pH) | (Low pH) | (Low pH) | (Low pH) |
| Citric acid | 10 | 10 | 10 | 10 |
| C₁₁₋₁₃LAS | 14.7 | 3.0 | — | — |
| C₁₂₋₁₄AS | — | — | — | 14.7 |
| AOS | — | — | 14.7 | — |
| C₁₂₋₁₄AE₃S | 3.0 | 14.7 | 3.0 | 3.0 |
| NaCS | 3.0 | 3.0 | 3.0 | 3.0 |
| Antioxidant ^{a} | 0.075 | 0.075 | 0.075 | 0.075 |
| Polyethyleneimines ^{b} | 2.8 | 2.8 | 2.8 | 2.8 |
| Tinosan ®HP100 ^{c} | 0.03 | 0.03 | 0.03 | 0.03 |
| Water | Balance | Balance | Balance | Balance |
| Product pH | 2.74 | 2.44 | 2.44 | 2.44 |

^{a} Ralox ®35: Methyl ester of 3,5-bis(1,1-dimethylethyl)-4-hydroxy-benzenepropanoic acid.
^{b} Polyethyleneimines (PEI) polymer ethoxylated or ethoxylated and propoxylated, available from BASF
^{c} Tinosan ®HP100 is 4-4′-dichloro-2-hydroxy diphenyl ether, available from BASF

Similarly as in Example 1, in order to determine the deposition of antioxidants after washing, fabric tracers were washed by using samples in Table 3. Then, the deposition of the antioxidant on fabrics was determined in accordance with Test 1: Fabric Deposition Test of Antioxidants. As the data shown in Table 4, the presence of a relatively high level of LAS can provide a significantly improved deposition of antioxidants compared to other anionic surfactants.

TABLE 4

| | 5 | 6 | 7 | 8 |
|---|---|---|---|---|
| | (Low pH) | (Low pH) | (Low pH) | (Low pH) |
| Anionic surfactants | LAS: 14.7 | LAS: 3.0 | AOS: 14.7 | AS: 14.7 |
| | AES: 3.0 | AES: 14.7 | AES: 3.0 | AES: 3.0 |
| Antioxidant | 4.76 | 1.89 | 3.01 | 2.54 |
| Deposition (μg/g) | | | | |

### Example 3: Improved Flavor in Headspace of Antioxidant-Containing Low-pH Liquid Laundry Detergent Compositions Versus Nil-Antioxidant Low-pH Liquid Laundry Detergent Compositions

Two (2) sample liquid laundry detergent compositions were prepared containing the ingredients as shown in Table 5 below, in which Sample 9 comprises an antioxidant while Sample 10 does not comprise an antioxidant.

TABLE 5

| | 9 | 10 |
|---|---|---|
| Ingredients (wt %) | (Antioxidant) | (Nil-antioxidant) |
| Citric acid | 11 | 11 |
| C₁₁₋₁₃LAS | 9.5 | 9.5 |
| C₁₂₋₁₄AE₃S | 1.5 | 1.5 |
| C₁₂₋₁₄EO₇ | 6.25 | 6.25 |
| NaCS | 2.0 | 2.0 |
| Antioxidant ^{a} | 0.075 | — |
| Polyethyleneimines ^{b} | 1.4 | 1.4 |
| Tinosan ®HP100 ^{c} | 0.04 | 0.04 |
| Perfume ^{d} | 0.7 | 0.7 |
| Silicone | 0.15 | 0.15 |
| NaOH | 1.87 | 1.87 |
| Water | Balance | Balance |
| Product pH | 2.5 | 2.5 |

^{a} Ralox ®35: Methyl ester of 3,5-bis(1,1-dimethylethyl)-4-hydroxy-benzenepropanoic acid.
^{b} Polyethyleneimines (PEI) polymer ethoxylated or ethoxylated and propoxylated, available from BASF.
^{c} Tinosan ®HP100 is 4-4′-dichloro-2-hydroxy diphenyl ether, available from BASF.
^{d} Perfume oil commercially available.

Levels of perfume raw materials (PRM) in the headspace of Samples 9 and 10 were determined by the following method:

### GCMS (Gas Chromatography-Mass Spectroscopy) Equipment:

Agilent Technologies 7800B GC System
Agilent Technologies 5977B MSD
Column: Agilent Technologies 122-5532UI DB-5 MS UI 30 m*0.250 mm, 0.25 Micro, −60 to 325/350 C, SN: USN754641H
Gerstel MultiPurpose Sampler
SPME (Solid Phase Micro Extraction) Fiber Assembly 50/30 um DVB/CAR/PDMS, Stableflex (2 cm) 23Ga, Autosampler, Gray-Notched, SUPELCO 57299-U

### Sample Preparation Procedure:

1. Weigh 0.5 g of the liquid detergent composition (Sample 1 or 9) which is newly prepared into a 20 ml headspace vial, then capped the vial.
2. Capped vial is being equilibrated for 18 h under room temperature (25 C).
4. Headspace vial is loaded to GCMS for analysis.

### GCMS Injection Procedure:

1. The SPME fiber will extract the headspace for 1 min under room temperature.
2. The SPME fiber will then move to GCMS injection port to desorb for 3 min under 270 C.
3. The desorbed content will go into GCMS for analysis with 20:1 split in GC and scan mode in MS.

GCMS response data is processed & quantified by Agilent MassHunter Quantification software with quantification method. As shown below, the results indicate that the introduction of the antioxidant has significantly improved flavor in the headspace of antioxidant-containing low-pH liquid laundry detergent compositions compared to nil-antioxidant compositions.

TABLE 6

| | Ratio of PRM levels |
|---|---|
| | between Sample 1 and |
| | Sample 9 (Antioxidant |
| Name | vs. nil Antioxidant) |
| 1,5-dimethyl-1-ethenylhex-4-enyl acetate | 1.052 |
| acetic acid 3-methyl-2-butenyl ester | 1.101 |
| 7-methyl-3-methylene-1,6-octadiene | 1.039 |
| acetic acid 3-methyl butyl ester | 1.008 |
| caprylic aldehyde | 1.212 |
| 2,2,6-trimethyl bicyclo(3.1.1)hept-2-ene | 1.014 |
| 3,7,7-trimethylbicyclo[4.1.0]hept-3-ene | 1.077 |
| hexyl ethanoate | 1.162 |
| 2,6-dimethyloct-7-en-2-ol | 1.154 |
| 1-(2,6,6-trimethyl-1-cyclohex-2-enyl)but-3-en-1- | 1.079 |
| one | |
| 2-methyl pentanoic acid ethyl ester | 1.032 |
| 1,8 9-para-menthadiene | 1.005 |
| 2,4-dimethyl-3-cyclohexene carboxaldehyde | 1.112 |
| 3,7-dimethyl-octan-3-ol | 1.105 |
| 2-(4-methyl-3-cyclohexen-1-yl)-2-propanyl | 1.085 |
| acetate | |
| 2,6,6-trimethyl bicyclo(3.1.1)hept-2-ene | 1.016 |
| 2-tert-butylcyclohexanol acetate | 1.064 |

### Example 4: Exemplary Liquid Laundry Detergent Compositions

Liquid laundry detergent compositions A-F are made by mixing together the ingredients listed in the proportions shown:

TABLE 7

| Ingredients (wt %) | A | B | C | D | E | F |
|---|---|---|---|---|---|---|
| Ralox ®35¹ | 0.001 | 0.075 | — | 0.05 | 0.5 | — |
| Tinogard ® TS² | 0.001 | — | 0.05 | 0.025 | — | 0.5 |
| NI 24-7³ and/or NI | 10 | 8 | 20 | 15 | 12 | — |
| 24-9⁴ | | | | | | |
| LAS⁵ | 5 | 10 | 6 | 8 | 5 | 15 |
| AE3S⁶ | 5 | 1 | 8 | 2 | 5 | 25 |
| Internal olefine sulfate | — | 3 | 10 | 3 | 5 | — |
| 2-alkyl branched alkyl | 4 | — | — | 3 | — | — |
| ethoxy sulfate | | | | | | |
| Fatty acids | 0 | 1.5 | 0 | 0.5 | 1.2 | — |
| DTPA | 1 | 0 | 0.1 | 0.5 | 0.3 | 0.8 |
| Citric acids | 8 | 12 | 6 | 10 | 15 | 8 |
| NaCS | 0 | 1.0 | 6.0 | 4.0 | 3.0 | 5.0 |
| NaOH | Neat product pH adjusted to 2.0-4.0 | | | | | |
| Perfume | 0.1 | 0.2 | 0.5 | 0.2 | 0.2 | 0.2 |
| Misc. (enzymes, dyes, | 0.5-2 | 0.5-2 | 0.5-2 | 0.5-2 | 0.5-2 | 0.5-2 |
| brighteners, chelants, | | | | | | |
| etc.) | | | | | | |
| Water | Q.S. | Q.S. | Q.S. | Q.S. | Q.S. | Q.S. |

¹Methyl ester of 3,5-bis(1,1-dimethylethyl)-4-hydroxy-benzenepropanoic acid.
²Octadecyl ester of 3,5-bis(1,1-dimethylethyl)-4-hydroxy-benzenepropanoic acid.
³A C12-C14 alkyl ethoxylated alcohol with a weight average degree of ethoxylation of 7.
⁴A C12-C14 alkyl ethoxylated alcohol with a weight average degree of ethoxylation of 9.
⁵A C₁₁-C₁₂ linear alkylbenzene sulphonate.
⁶A C₁₂₋₁₄ alkyl ethoxylated sulfate with a weight average degree of ethoxylation of about 3.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A liquid laundry detergent composition comprising:
a) from 0.001 wt % to 5 wt % of a hindered phenol antioxidant,
b) from 5 wt % to 60 wt % of a C₆-C₂₀ linear alkylbenzene sulfonate (LAS),
c) from 0.1 wt % to 30 wt % of an additional surfactant, and
d) from 4.5% to 40% by weight of the composition of an organic acid,
wherein the composition has a neat pH of from 1.5 to 5.0.

2. The liquid laundry detergent composition of claim 1, wherein the LAS is the majority surfactant in the detergent composition.

3. The liquid laundry detergent composition of claim 1, wherein the hindered phenol antioxidant comprises at least one phenolic —OH group having: (a) at least one C₃-C₂₂ branched alkyl at a position ortho to said at least one phenolic —OH group; or (b) substitutes at each position ortho to said at least one phenolic —OH group, wherein said substitutes are independently selected from the group consisting of hydroxy, C₁-C₆ alkoxy, C₁-C₂₂ linear alkyl, and combinations thereof.

4. The liquid laundry detergent composition according to claim 1, wherein the additional surfactant is selected from the group consisting of alkyl alkoxylated alcohols, alkyl alkoxylated phenols, alkyl polysaccharides, polyhydroxy fatty acid amides, alkoxylated fatty acid esters, sucrose esters, sorbitan esters and alkoxylated derivatives of sorbitan esters, C₆-C₂₀ alkyl sulfates (AS), C₆-C₂₀ alkyl alkoxy sulfates (AAS), C₆-C₂₀ methyl ester sulfonates (MES), C₆-C₂₀ alkyl ether carboxylates (AEC), alpha olefin sulphonates (AOS), and any combinations thereof.

5. The liquid laundry detergent composition according to claim 1, wherein the organic acid is selected from the group consisting of citric acid, lactic acid, tartaric acid, malic acid and any combinations thereof.

6. The liquid laundry detergent composition according to claim 1, wherein said hindered phenol antioxidant is present in said liquid laundry detergent composition at an amount ranging from 0.005 wt % to 2 wt %; and/or
wherein the LAS is present in said liquid laundry detergent composition at an amount ranging from 6 wt % to 50 wt %; and/or
wherein the additional surfactant is present in said liquid laundry detergent composition at an amount ranging from 0.2 wt % to 30 wt %; and/or
wherein the organic acid is present in said liquid laundry detergent composition at an amount ranging from 6 wt % to 30 wt %.

7. The liquid laundry detergent composition according to claim 1, wherein the composition has a neat pH of from 1.6 to 4.5.

8. The liquid laundry detergent composition according to claim 1, wherein the composition further comprises a polyalkylene imine polymer.

9. The liquid laundry detergent composition according to claim 1, wherein the composition further comprises a treatment adjunct which is selected from the group consisting of fatty acids and/or salts thereof, enzymes, encapsulated benefit agents, soil release polymers, hueing agents, builders, chelating agents, dye transfer inhibiting agents, dispersants, enzyme stabilizers, anti-oxidants, catalytic materials, bleaching agents, bleach catalysts, bleach activators, polymeric dispersing agents, soil removal/anti-redeposition agents, polymeric grease cleaning agents, amphiphilic copolymers, brighteners, suds suppressors, dyes, hueing agents, perfume, structure elasticizing agents, fabric softeners, carriers, fillers, hydrotropes, solvents, anti-microbial agents and/or preservatives, neutralizers and/or pH adjusting agents, processing aids, rheology modifiers and/or structurants, opacifiers, pearlescent agents, pigments, anti-corrosion and/or anti-tarnishing agents, and mixtures thereof.

10. The liquid laundry detergent composition according to claim 1, wherein the composition further comprises one or more perfume raw materials selected from the group consisting of 1, 5-dimethyl-1-ethenylhex-4-enyl acetate, acetic acid 3-methyl-2-butenyl ester, 7-methyl-3-methylene-1,6-octadiene, acetic acid 3-methyl butyl ester, caprylic aldehyde, 2,2,6-trimethyl bicyclo(3.1.1) hept-2-ene, 3,7,7-trimethylbicyclo[4.1.0]hept-3-ene, hexyl ethanoate, 2,6-dimethyloct-7-en-2-ol, 1-(2,6,6-trimethyl-1-cyclohex-2-enyl) but-3-en-1-one, 2-methyl pentanoic acid ethyl ester, 1,8 9-para-menthadiene, 2,4-dimethyl-3-cyclohexene carboxaldehyde, 3,7-dimethyl-octan-3-ol, 2-(4-methyl-3-cyclohexen-1-yl)-2-propanyl acetate, 2,6,6-trimethyl bicyclo(3.1.1) hept-2-ene, 2-tert-butylcyclohexanol acetate, and any combinations thereof.

11. A liquid laundry detergent composition comprising:
a) from 0.02 wt % to 0.5 wt % of a hindered phenol antioxidant selected from the group consisting of C₁-C₂₂ linear alkyl esters of 3,5-bis(1,1-dimethylethyl)-4-hydroxy-benzenepropanoic acid and mixtures thereof;
b) from 8 wt % to 40 wt % of a C₁₀-C₂₀ linear alkyl benzene sulphonate (LAS);
c) from 2 wt % to 8 wt % of an additional surfactant selected from the group consisting of a C₁₀-C₂₀ linear or branched alkylethoxy sulfate (AES) having a weight average degree of ethoxylation ranging from 1 to 3, C₈-C₁₈ alkyl ethoxylated alcohols having a weight average degree of ethoxylation ranging from 7 to 10, a C₆-C₂₀ alkyl sulfates (AS), alpha olefin sulphonates (AOS), and any combinations thereof; and
d) from 8% to 20% by weight of the composition of a citric acid,
wherein the composition has a neat pH of from 2 to 3.

12. Use of the liquid laundry detergent composition according to claim 11 for removing malodor.
